(19) United States
(12) Patent Application Publication
(10) Pub. No.: US 2007/0053005 A1
(43) Pub. Date: Mar. 8, 2007

(54) Copying

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Holdings (UK) Limited, London (GB)

(21) Appl. No.: 11/530,454

(22) Filed: Sep. 8, 2006

Related U.S. Application Data
(60) Provisional application No. 60/715,044, filed on Sep. 8, 2005.

(30) Foreign Application Priority Data
Sep. 8, 2005 (GB) 0518342.1

(51) Int. Cl. H04N 1/40; G06K 15/00

(52) U.S. Cl. 358/3.28

(57) ABSTRACT

A system for controlling reproduction of a document. The system can comprise a signature determination unit operable to determine a signature from a document based upon an intrinsic characteristic of the document, and a comparison unit operable to compare the determined signature to a stored signature. The system can also comprise a reproduction apparatus operable to create a reproduction of the document in dependence upon a comparison result from the comparison unit.

This application claims priority to and incorporates by reference U.S. provisional application No. 60/715,044 filed Sep. 8, 2005, and Great Britain patent application number GB 0518342.1 filed on Sep. 8, 2005.

### FIELD

The present invention relates to copying, and in particular but not exclusively to copying of an article, the legitimate or authorised copying of which subject to restrictions.

Many traditional copy security systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do.

Because of this, there is a known approach to authentication security systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match.

### SUMMARY

The present invention has been made, at least in part, in consideration of problems and drawbacks of conventional systems.

The present invention has at least in part resulted from the inventor's work on applying authentication techniques using tokens made of magnetic materials, where the uniqueness is provided by unreproducible defects in the magnetic material that affect the token's magnetic response (as detailed in WO2004/025548, Cowburn). As part of this work, magnetic materials were fabricated in barcode format, i.e. as a number of parallel strips. As well as reading the unique magnetic response of the strips by sweeping a magnetic field with a magnetic reader, an optical scanner was built to read the barcodes by scanning a laser beam over the barcode and using contrast from the varying reflectivity of the barcode strips and the article on which they were formed. This information was complementary to the magnetic characteristic, since the barcode was being used to encode a digital signature of the unique magnetic response in a type of well known self authentication scheme, for example as also described above for banknotes (see for example, Kravolec “Plastic tag makes foolproof ID”, Technology research news, 2 Oct. 2002).

To the surprise of the inventor, it was discovered when using this optical scanner that the paper background material on which the magnetic chips were supported gave a unique optical response to the scanner. On further investigation, it was established that many other unprepared surfaces, such as surfaces of various types of cardboard and plastic, show the same effect. Moreover, it has been established by the inventor that the unique characteristic arises at least in part from speckle, but also includes non-speckle contributions.

It has thus been discovered that it is possible to gain all the advantages of speckle based techniques without having to use a specially prepared token or specially prepare an article in any other way. In particular, many types of paper, cardboard and plastics have been found to give unique characteristic scattering signals from a coherent light beam, so that unique digital signatures can be obtained from almost any paper document or cardboard packaging item.

The above-described known speckle readers used for security devices appear to be based on illuminating the whole of a token with a laser beam and imaging a significant solid angle portion of the resultant speckle pattern with a CCD (see for example GB 2 221 870 and U.S. Pat. No. 6,584,214), thereby obtaining a speckle pattern image of the token made up of a large array of data points.

The reader used by the inventor does not operate in this manner. It uses four single channel detectors (four simple phototransistors) which are angularly spaced apart to collect only four signal components from the scattered laser beam. The laser beam is focused to a spot covering only a very small part of the surface. Signal is collected from different localised areas on the surface by the four single channel detectors as the spot is scanned over the surface. The characteristic response from the article is thus made up of independent measurements from a large number (typically hundreds or thousands) of different localised areas on the article surface. Although four phototransistors are used, analysis using only data from a single one of the phototransistors shows that a unique characteristic response can be derived from this single channel alone! However, higher security levels are obtained if further ones of the four channels are included in the response.

Viewed from a first aspect, the present invention can provide a system for controlling reproduction of a document. The system comprises a signature determination unit operable to determine a signature from a document based upon an intrinsic characteristic of the document, and a comparison unit operable to compare the determined signature to a stored signature. The system also comprises a reproduction apparatus operable to create a reproduction of the document in dependence upon a comparison result from the comparison unit. Thereby reproduction of a document can be controlled and restricted in dependence upon a document copying policy associated with that document. In some examples, the copying can be further controlled on the basis of the authority of a particular user to make copies of a document. Thereby, total copy numbers can be restricted, and individual copies can be traced to an individual who produced them. In some examples, certified copies of a document can be created as can certified second and subsequent generation copies.

In some embodiments, it is ensured that different ones of the data gathered in relation to the intrinsic property of the article relate to scatter from different parts of the article by providing for movement of the coherent beam relative to the article. The movement may be provided by a motor that moves the beam over an article that is held fixed. The motor could be a servo motor, free running motor, stepper motor or any suitable motor type. Alternatively, the drive could be manual in a low cost reader. For example, the operator could scan the beam over the article by moving a carriage on which the article is mounted across a static beam. The coherent beam cross-section will usually be at least one order of magnitude (preferably at least two) smaller than the projection of the article so that a significant number of independent data points can be collected. A focusing arrangement may be provided for bringing the coherent beam into focus in the article. The focusing arrangement may be configured to bring the coherent beam to an elongate focus, in which case the drive is preferably configured to move the coherent beam over the article in a direction transverse to the major axis of the elongate focus. An elongate focus can conveniently be provided with a cylindrical lens, or equivalent mirror arrangement.

In other embodiments, it can be ensured that different ones of the data points relate to scatter from different parts of the article, in that the detector arrangement includes a plurality of detector channels arranged and configured to sense scatter from respective different parts of the article. This can be achieved with directional detectors, local collection of signal with optical fibres or other measures. With directional detectors or other localised collection of signal, the coherent beam does not need to be focused. Indeed, the coherent beam could be static and illuminate the whole sampling volume. Directional detectors could be implemented by focusing lenses fused to, or otherwise fixed in relation to, the detector elements. Optical fibres may be used in conjunction with microlenses.

It is possible to make a workable reader when the detector arrangement consists of only a single detector channel. Other embodiments use a detector arrangement that comprises a group of detector elements angularly distributed and operable to collect a group of data points for each different part of the reading volume, preferably a small group of a few detector elements. Security enhancement is provided when the signature incorporates a contribution from a comparison between data points of the same group. This comparison may conveniently involve a cross-correlation.

Although a working reader can be made with only one detector channel, there are preferably at least 2 channels. This allows cross-correlations between the detector signals to be made, which is useful for the signal processing associated with determining the signature. It is envisaged that between 2 and 10 detector channels will be suitable for most applications with 2 to 4 currently being considered as the optimum balance between apparatus simplicity and security.

The detector elements are advantageously arranged to lie in a plane intersecting the reading volume with each member of the pair being angularly distributed in the plane in relation to the coherent beam axis, preferably with one or more detector elements either side of the beam axis. However, non-planar detector arrangements are also acceptable.

The use of cross-correlations of the signals obtained from the different detectors has been found to give valuable data for increasing the security levels and also for allowing the signatures to be more reliably reproducible over time. The utility of the cross-correlations is somewhat surprising from a scientific point of view, since speckle patterns are inherently uncorrelated (with the exception of signals from opposed points in the pattern). In other words, for a speckle pattern there will by definition be zero cross-correlation between the signals from the different detectors so long as they are not arranged at equal magnitude angles offset from the excitation location in a common plane intersecting the excitation location. The value of using cross-correlation contributions therefore indicates that an important part of the scatter signal is not speckle. The non-speckle contribution could be viewed as being the result of direct scatter, or a diffuse scattering contribution, from a complex surface, such as paper fibre twists. At present the relative importance of the speckle and non-speckle scatter signal contribution is not clear. However, it is clear from the experiments performed to date that the detectors are not measuring a pure speckle pattern, but a composite signal with speckle and non-speckle components.

Incorporating a cross-correlation component in the signature can also be of benefit for improving security. This is because, even if it is possible using high resolution printing to make an article that reproduces the contrast variations over the surface of the genuine article, this would not be able to match the cross-correlation coefficients obtained by scanning the genuine article.

In one embodiment, the detector channels are made up of discrete detector components in the form of simple phototransistors. Other simple discrete components could be used such as PIN diodes or photodiodes. Integrated detector components, such as a detector array could also be used, although this would add to the cost and complexity of the device.

From initial experiments which modify the illumination angle of the laser beam on the article to be scanned, it also seems to be preferable in practice that the laser beam is incident approximately normal to the surface being scanned in order to obtain a characteristic that can be repeatedly measured from the same surface with little change, even when the article is degraded between measurements. At least some known readers use oblique incidence (see GB 2 221 870). Once appreciated, this effect seems obvious, but it is clearly not immediately apparent as evidenced by the design of some prior art speckle readers including that of GB 2 221 870 and indeed the first prototype reader built by the inventor. The inventor's first prototype reader with oblique incidence functioned reasonably well in laboratory conditions, but was quite sensitive to degradation of the paper used as the article. For example, rubbing the paper with fingers was sufficient to cause significant differences to appear upon re-measurement. The second prototype reader used normal incidence and has been found to be robust against degradation of paper by routine handling, and also more severe events such as: passing through various types of printer including a laser printer, passing through a photocopier machine, writing on, printing on, deliberate scorching in an oven, and crushing and reflattening.

It can therefore be advantageous to mount the source so as to direct the coherent beam onto the reading volume so that it will strike an article with near normal incidence. By near normal incidence means ±5, 10 or 20 degrees. Alternatively, the beam can be directed to have oblique incidence on the articles. This will usually have a negative influence in the case that the beam is scanned over the article.

It is also noted that in the readers described in the detailed description, the detector arrangement is arranged in reflection to detect radiation back scattered from the reading volume. However, if the article is transparent, the detectors could be arranged in transmission.

A signature generator can be operable to access the database of previously recorded signatures and perform a comparison to establish whether the database contains a match to the signature of an article that has been placed in the reading volume. The database may be part of a mass storage device that forms part of the reader apparatus, or may be at a remote location and accessed by the reader through a telecommunications link. The telecommunications link may take any conventional form, including wireless and fixed links, and may be available over the internet. The data acquisition and processing module may be operable, at least in some operational modes, to allow the signature to be added to the database if no match is found.

When using a database, in addition to storing the signature it may also be useful to associate that signature in the database with other information about the article such as a scanned copy of the document, a photograph of a passport holder, details on the place and time of manufacture of the product, or details on the intended sales destination of vendable goods (e.g. to track grey importation).

The invention allows identification of articles made of a variety of different kinds of materials, such as paper, cardboard and plastic.

By intrinsic structure we mean structure that the article inherently will have by virtue of its manufacture, thereby distinguishing over structure specifically provided for security purposes, such as structure given by tokens or artificial fibres incorporated in the article.

By paper or cardboard we mean any article made from wood pulp or equivalent fibre process. The paper or cardboard may be treated with coatings or impregnations or covered with transparent material, such as cellophane. If long-term stability of the surface is a particular concern, the paper may be treated with an acrylic spray-on transparent coating, for example.

Data points can thus be collected as a function of position of illumination by the coherent beam. This can be achieved either by scanning a localised coherent beam over the article, or by using directional detectors to collect scattered light from different parts of the article, or by a combination of both.

The signature is envisaged to be a digital signature in most applications. Typical sizes of the digital signature with current technology would be in the range 200 bits to 8 k bits, where currently it is preferable to have a digital signature size of about 2 k bits for high security.

A further implementation of the invention can be performed without storing the digital signatures in a database, but rather by labelling the entitlement token with a label derived from the signature, wherein the label conforms to a machine-readable encoding protocol.

### BRIEF DESCRIPTION OF THE FIGURES

Specific embodiments of the present invention will now be described by way of example only with reference to the accompanying figures in which:

FIG. 1 is a schematic side view of an example of a reader apparatus;

FIG. 2 is a schematic perspective view showing how the reading volume of the reader apparatus of FIG. 1 is sampled;

FIG. 3 is a block schematic diagram of functional components of the reader apparatus of FIG. 1;

FIG. 4 is a perspective view of a first example of a copying apparatus using the reader apparatus of FIG. 1;

FIG. 5 is a perspective view of a second example of a copying apparatus using the reader apparatus of FIG. 1;

FIG. 6A shows schematically in side view an alternative imaging arrangement for a reader based on directional light collection and blanket illumination;

FIG. 6B shows schematically in plan view the optical footprint of a further alternative imaging arrangement for a reader in which directional detectors are used in combination with localised illumination with an elongate beam;

FIG. 7 is a microscope image of a paper surface with the image covering an area of approximately 0.5×0.2 mm;

FIG. 8A shows raw data from a single photodetector using the reader of FIG. 1 which consists of a photodetector signal and an encoder signal;

FIG. 8B shows the photodetector data of FIG. 9A after linearisation with the encoder signal and averaging the amplitude;

FIG. 8C shows the data of FIG. 9B after digitisation according to the average level;

FIG. 9 is a flow diagram showing how a signature of an article is generated from a scan;

FIG. 10 is a flow diagram showing how a signature of an article obtained from a scan can be verified against a signature database;

FIG. 11 is a flow diagram showing how the verification process of FIG. 11 can be altered to account for non-idealities in a scan;

FIG. 12A shows an example of cross-correlation data data gathered from a scan;

FIG. 12b shows an example of cross-correlation data data gathered from a scan where the scanned article is distorted; and

FIG. 12C shows an example of cross-correlation data data gathered from a scan where the scanned article is scanned at non-linear speed.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DESCRIPTION OF PARTICULAR EMBODIMENTS

For providing security and authorisation services in environments such as an e-commerce environment, a system for uniquely identifying a physical item can be used to reduce possibilities for fraud, and to enhance both actual and perceived reliability of the e-commerce system, for both provider and end-users.

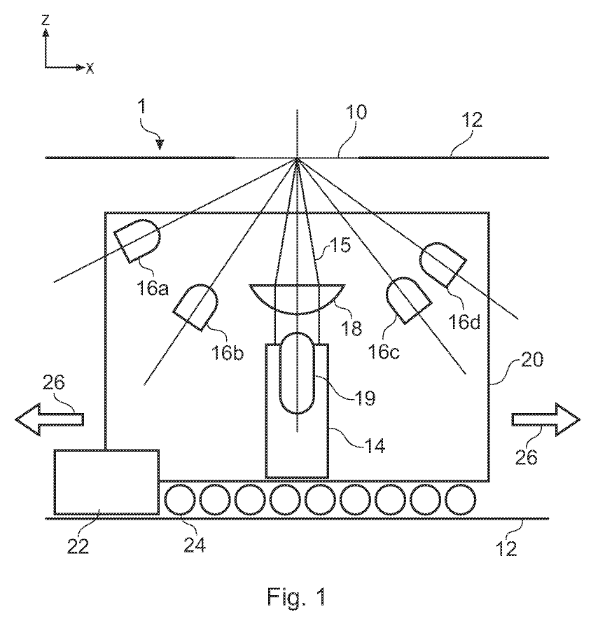

Examples of systems suitable for performing such item identification will now be described with reference to FIGS. 1 to 12.

FIG. 1 shows a schematic side view of a first example of a reader apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=4 in this example, labelled 16a, 16b, 16c and 16d. The laser beam 15 is focused by a cylindrical lens 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20. In the present example, the four detector elements 16a . . . d are distributed either side of the beam axis offset at different angles in an interdigitated arrangement from the beam axis to collect light scattered in reflection from an article present in the reading volume. In the present example, the offset angles are 31 70, −20, +30 and +50 degrees. The angles either side of the beam axis are chosen so as not to be equal so that the data points they collect are as independent as possible. All four detector elements are arranged in a common plane. The photodetector elements 16a . . . d detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In the present example, the depth of focus is approximately 0.5 mm which is sufficiently large to produce good results where the position of the article relative to the scanner can be controlled to some extent. The parameters, of depth of focus, numerical aperture and working distance are interdependent, resulting in a well known trade off between spot size and depth of focus.

A drive motor 22 is arranged in the housing 12 for providing linear motion of the optics subassembly 20 via suitable bearings 24 or other means, as indicated by the arrows 26. The drive motor 22 thus serves to move the coherent beam linearly in the x direction over the reading aperture 10 so that the beam 15 is scanned in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the housing wall in which the reading aperture is set, a scan of the drive motor 22 will cause the coherent beam 15 to sample many different parts of the reading volume under action of the drive motor 22.

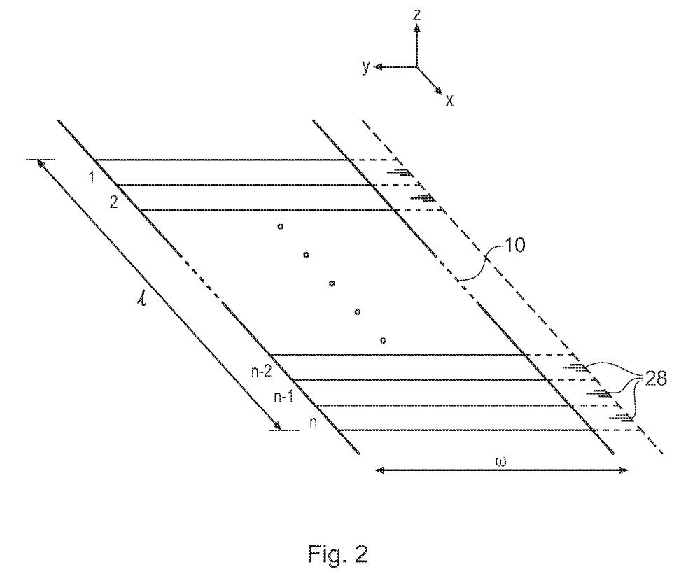

FIG. 2 is included to illustrate this sampling and is a schematic perspective view showing how the reading area is sampled n times by scanning an elongate beam across it. The sampling positions of the focused laser beam as it is scanned along the reading aperture under action of the drive is represented by the adjacent rectangles numbered 1 to n which sample an area of length ‘l’ and width ‘w’. Data collection is made so as to collect signal at each of the n positions as the drive is scanned along the slit. Consequently, a sequence of k×n data points are collected that relate to scatter from the n different illustrated parts of the reading volume.

Also illustrated schematically are optional distance marks 28 formed on the underside of the housing 12 adjacent the slit 10 along the x direction, i.e. the scan direction. An example spacing between the marks in the x-direction is 300 micrometres. These marks are sampled by a tail of the elongate focus and provide for linearisation of the data in the x direction in situations where such linearisation is required, as is described in more detail further below. The measurement is performed by an additional phototransistor 19 which is a directional detector arranged to collect light from the area of the marks 28 adjacent the slit.

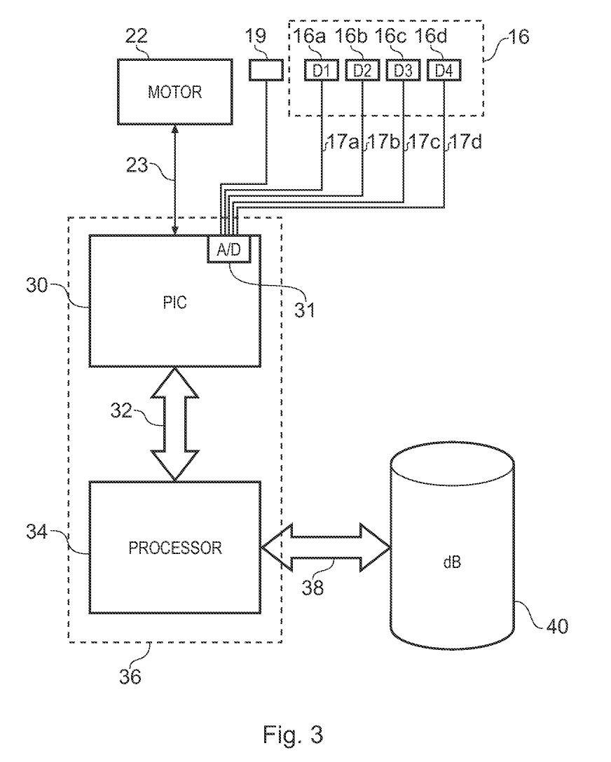

In alternative examples, the marks 28 can be read by a dedicated encoder emitter/detector module 19 that is part of the optics subassembly 20. Encoder emitter/detector modules are used in bar code readers. In one example, an Agilent HEDS-1500 module that is based on a focused light emitting diode (LED) and photodetector can be used. The module signal is fed into the PIC ADC as an extra detector channel (see discussion of FIG. 3 below).

With an example minor dimension of the focus of 40 micrometers, and a scan length in the x direction of 2 cm, n=500, giving 2000 data points with k=4. A typical range of values for k×n depending on desired security level, article type, number of detector channels ‘k’ and other factors is expected to be 100<k×n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k×n, should be 500 or more to give an acceptably high security level with a wide variety of surfaces. Other minima (either higher or lower) may apply where a scanner is intended for use with only one specific surface type or group of surface types.

FIG. 3 is a block schematic diagram of functional components of the reader apparatus. The motor 22 is connected to a programmable interrupt controller (PIC) 30 through an electrical link 23. The detectors 16a . . . d of the detector module 16 are connected through respective electrical connection lines 17a . . . d to an analogue-to-digital converter (ADC) that is part of the PIC 30. A similar electrical connection line 21 connects the marker reading detector 19 to the PIC 30. It will be understood that optical or wireless links may be used instead of, or in combination with, electrical links. The PIC 30 is interfaced with a processor 34 through a data connection 32. The processor 34 may be a desktop or a laptop. The processor 34 may be incorporated into a conventional processing apparatus such as a PC or other intelligent device, such as a personal digital assistant (PDA) or a dedicated electronics unit. The PIC 30 may also be incorporated into such processing apparatus. The PIC 30 and processor 34 collectively form a data acquisition and processing module 36 for determining a signature of the article from the set of data points collected by the detectors 16a . . . d.

In some examples, the processor 34 can have access through an interface connection 38 to a database (dB) 40. The database 40 may be resident on the PC 34 in memory, or stored on a drive thereof. Alternatively, the database 40 may be remote from the processor 34 and accessed by wireless communication, for example using mobile telephony services or a wireless local area network (LAN) in combination with the internet. Moreover, the database 40 may be stored locally so as to be accessible by the processor 34, but periodically downloaded from a remote source. The database may be administered by a remote entity, which entity may provide access to only a part of the total database to the particular processor 34, and/or may limit access the database on the basis of a security policy.

The database 40 can contain a library of previously recorded signatures. The processor 34 can be programmed so that in use it can access the database 40 and performs a comparison to establish whether the database 40 contains a match to the signature of the article that has been placed in the reading volume. The processor 34 can also be programmed to allow a signature to be added to the database if no match is found.

The way in which data flow between the processor and database is handled can be dependent upon the location of the processor and the relationship between the operator of the processor and the operator of the database. For example, if the processor and reader are being used to confirm the authenticity of an article, then the processor will not need to be able to add new articles to the database, and may in fact not directly access the database, but instead provide the signature to the database for comparison. In this arrangement the database may provide an authenticity result to the processor to indicate whether the article is authentic. On the other hand, if the processor and reader are being used to record or validate an item within the database, then the signature can be provided to the database for storage therein, and no comparison may be needed. In this situation a comparison could be performed however, to avoid a single item being entered into the database twice.

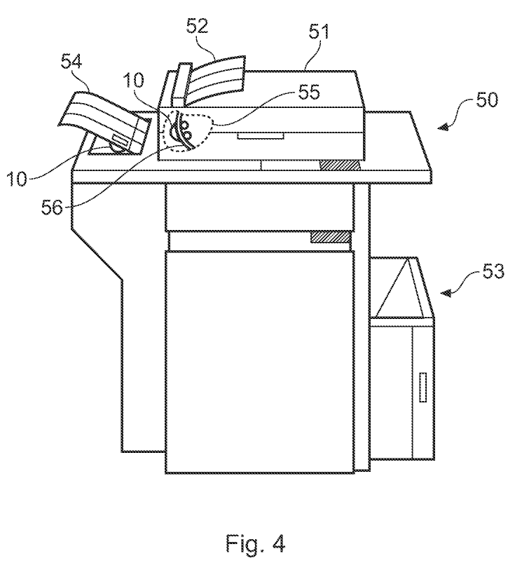

FIG. 4 is a perspective view of a photocopier 50 with the above-described scan head 10 integrated into it. The photocopier 50 can be conventional other than by virtue of the scan head and associated electronics. The photocopier 50 can have conventional features such as a document scanning unit 51, which may include an automatic sheet feeder unit 52. Also, a paper tray 53 may be provided for holding media to be copied onto. The photocopier 50 may also have a document output tray 54 to allow a user easy access to copies made using the photocopier 50. Conventional photocopier machines are manufactured by a number of companies, including Xerox™ Inc and Canon™ K.K.

In the photocopier 50 of the present example, a scan head 10 is integrated into each of the document scanning unit 51 and the document output tray 54. As illustrated in cutaway portion 55, the document scanning unit 51 of the present example includes a scan head 10 in a paper path 56 of the automatic sheet feeder unit 52 so as to allow scanning of documents being copied. The document output tray 54 also has a scan head 10 integrated thereinto, so as to be able to scan output documents.

It will be appreciated that the scan heads 10 could be mounted in many different positions along the respective feed paths of the copied documents and of the copy documents created by the photocopier.

In another example, documents may be copied using a linked scanner machine and printer machine. In such an example, the scanner machine can be equipped with a scan head to scan documents being scanned, and the printer machine can be equipped with a scan head to scan documents being printed. Thus, what is effectively a two-part photocopier can be used.

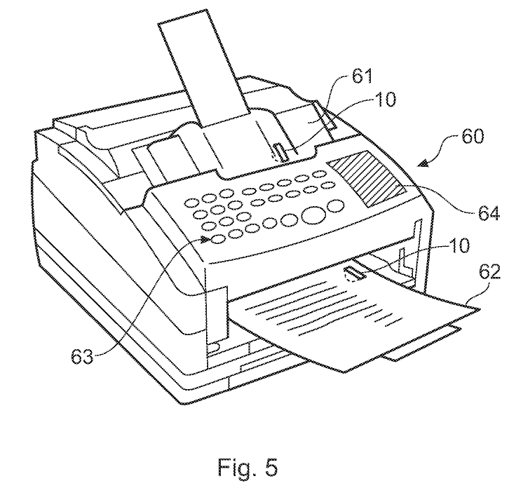

FIG. 5 is a perspective view of a facsimile machine 60 with the above-described scan head 10 integrated into it. The facsimile machine 60 can be conventional other than by virtue of the scan head and associated electronics. The facsimile machine 60 can have conventional features such as a document feed unit 61, and an output tray 62 for holding documents which have been transmitted via facsimile, transmission receipts produced by the facsimile machine 60 and printed copied of documents received via facsimile. The facsimile machine 60 may also have control keys 63 to allow a user to program a transmission destination, and a screen 64 for transmission and operation information to be displayed to a user. Conventional facsimile machines are manufactured by a number of companies, including Xerox™ Inc and Canon™ K.K.

In the facsimile machine 60 of the present example, a scan head 10 is integrated into each of the document feed unit 61 and the output tray 62. As illustrated, the document feed unit 61 of the present example includes a scan head 10 so as to allow scanning of documents being transmitted. The output tray 64 also has a scan head 10 integrated thereinto, so as to be able to scan documents received at the facsimile machine 60.

It will be appreciated that the scan heads 10 could be mounted in many different positions along the respective feed paths of the documents for transmission and of the documents received by the facsimile machine.

In another example, a facsimile transmission may be effected by scanning a document into a computer and then performing a so-called e-fax transmission from the computer to another computer. This may also be performed using an email transmission. At the recipient, when reproducing the document onto paper, the print machine used to create the paper copy can also include a scan head to scan the new document.

Thus there has now been described an example of a scanning and signature generation apparatus suitable for use in a mechanism for traceable and secure copying of documents. Such a system can be deployed to allow a document to be scanned as part of a copying or electronic transmission process (such a transmission process can be considered to be a copying process where the copy is produced at a location remote the document being copied).

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

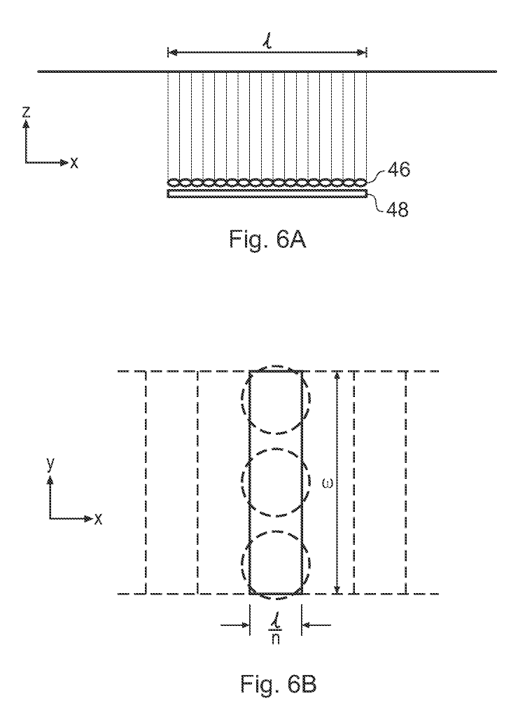

FIG. 6A shows schematically in side view such an imaging arrangement for a reader which is based on directional light collection and blanket illumination with a coherent beam. An array detector 48 is arranged in combination with a cylindrical microlens array 46 so that adjacent strips of the detector array 48 only collect light from corresponding adjacent strips in the reading volume. With reference to FIG. 2, each cylindrical microlens is arranged to collect light signal from one of the n sampling strips. The coherent illumination can then take place with blanket illumination of the whole reading volume (not shown in the illustration).

A hybrid system with a combination of localised excitation and localised detection may also be useful in some cases.

FIG. 6B shows schematically in plan view the optical footprint of such a hybrid imaging arrangement for a reader in which directional detectors are used in combination with localised illumination with an elongate beam. This example may be considered to be a development of the example of FIG. 1 in which directional detectors are provided. In this example three banks of directional detectors are provided, each bank being targeted to collect light from different portions along the ‘l×w’ excitation strip. The collection area from the plane of the reading volume are shown with the dotted circles, so that a first bank of, for example 2, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately l/m, where m is the number of subdivisions of the excitation strip, where m=3 in the present example. In this way the number of independent data points can be increased by a factor of m for a given scan length l. As described further below, one or more of different banks of directional detectors can be used for a purpose other than collecting light signal that samples a speckle pattern. For example, one of the banks may be used to collect light signal in a way optimised for barcode scanning. If this is the case, it will generally be sufficient for that bank to contain only one detector, since there will be no advantage obtaining cross-correlations when only scanning for contrast.

Having now described the principal structural components and functional components of various reader apparatuses, the numerical processing used to determine a signature will now be described. It will be understood that this numerical processing can be implemented for the most part in a computer program that runs on the processor 34 with some elements subordinated to the PIC 30. In alternative examples, the numerical processing could be performed by a dedicated numerical processing device or devices in hardware or firmware.

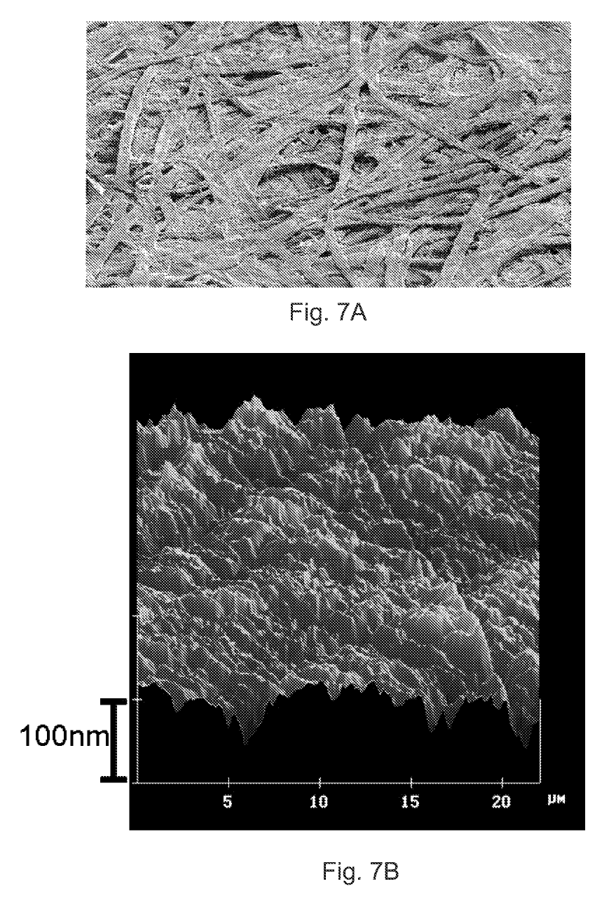

FIG. 7A is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other fibres that make up the paper. The figure is also illustrative of the characteristic length scale for the wood fibres which is around 10 microns. This dimension has the correct relationship to the optical wavelength of the coherent beam of the present example to cause diffraction and hence speckle, and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article and materials, for example plastics such as may be used to form a protective laminated film over a document, or as a substrate for a document.

FIG. 7B shows an equivalent image for a plastic surface. This atomic force microscopy image clearly shows the uneven surface of the macroscopically smooth plastic surface. As can be surmised from the figure, this surface is smoother than the paper surface illustrated in FIG. 7A, but even this level of surface undulation can be uniquely identified using the signature generation scheme of the present example.

In other words, it can be essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

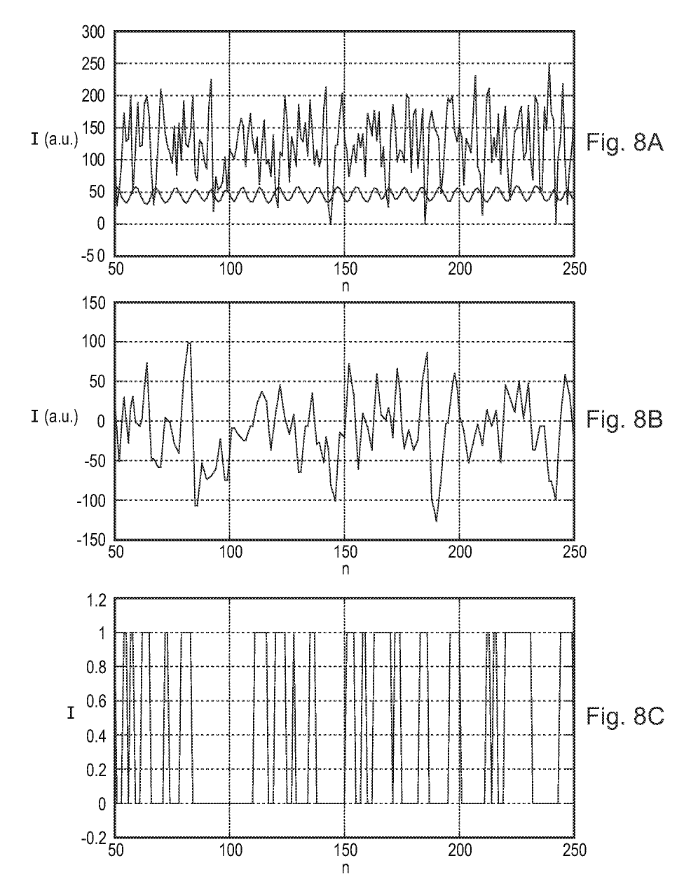

FIG. 8A shows raw data from a single one of the photodetectors 16a . . . d of the reader of FIG. 1. The graph plots signal intensity I in arbitrary units (a.u.) against point number n (see FIG. 2). The higher trace fluctuating between I=0−250 is the raw signal data from photodetector 16a. The lower trace is the encoder signal picked up from the markers 28 (see FIG. 2) which is at around I=50.

FIG. 8B shows the photodetector data of FIG. 8A after linearisation with the encoder signal (n.b. although the x axis is on a different scale from FIG. 8A, this is of no significance). As noted above, where a movement of the article relative to the scanner is sufficiently linear, there may be no need to make use of a linearisation relative to alignment marks. In addition, the average of the intensity has been computed and subtracted from the intensity values. The processed data values thus fluctuate above and below zero.

FIG. 8C shows the data of FIG. 8B after digitisation. The digitisation scheme adopted is a simple binary one in which any positive intensity values are set at value 1 and any negative intensity values are set at zero. It will be appreciated that multi-state digitisation could be used instead, or any one of many other possible digitisation approaches. The main important feature of the digitisation is merely that the same digitisation scheme is applied consistently.

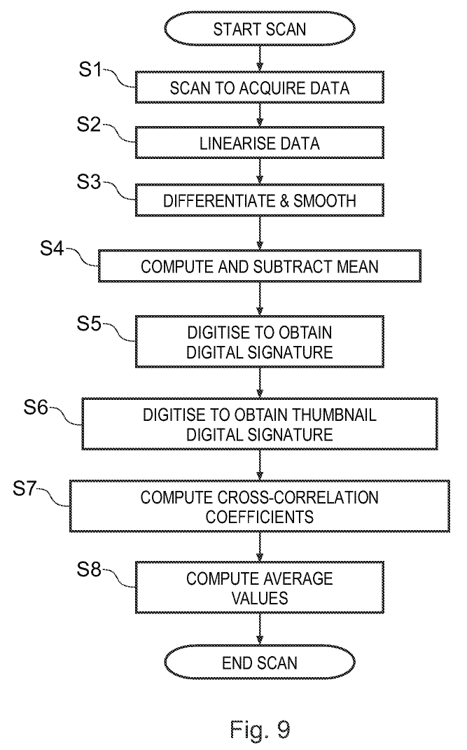

FIG. 9 is a flow diagram showing how a signature of an article is generated from a scan.

Step S1 is a data acquisition step during which the optical intensity at each of the photodetectors is acquired approximately every 1 ms during the entire length of scan. Simultaneously, the encoder signal is acquired as a function of time. It is noted that if the scan motor has a high degree of linearisation accuracy (e.g. as would a stepper motor) then linearisation of the data may not be required. The data is acquired by the PIC 30 taking data from the ADC 31. The data points are transferred in real time from the PIC 30 to the processor 34. Alternatively, the data points could be stored in memory in the PIC 30 and then passed to the processor 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 8A.

Step S2 uses numerical interpolation to locally expand and contract aₖ(i) so that the encoder transitions are evenly spaced in time. This corrects for local variations in the motor speed. This step can be performed in the processor 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated (speckle) contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 8B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the article may incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and aₗ(i), where k≠l and k,l vary across all of the photodetector channel numbers. The normalised cross-correlation function Γ is defined as

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The signature data obtained from scanning an article can be compared against records held in a signature database for verification purposes and/or written to the database to add a new record of the signature to extend the existing database.

A new database record will include the digital signature obtained in Step S5. This can optionally be supplemented by one or more of its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

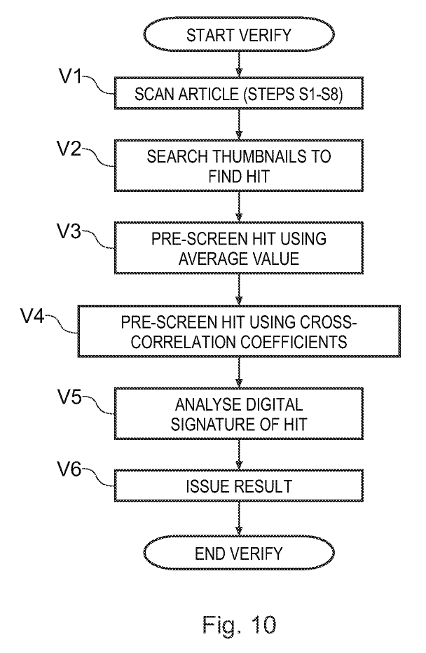

FIG. 10 is a flow diagram showing how a signature of an article obtained from a scan can be verified against a signature database.

In a simple implementation, the database could simply be searched to find a match based on the full set of signature data. However, to speed up the verification process, the process can use the smaller thumbnails and pre-screening based on the computed average values and cross-correlation coefficients as now described.

Verification Step V1 is the first step of the verification process, which is to scan an article according to the process described above, i.e. to perform Scan Steps S1 to S8.

Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. A typical value for q is 4 and a typical value for k is 4, making typically 16 bits per block. The qk bits are then matched against the qk corresponding bits in the stored digital signature dₖ^{db}(i+j). If the number of matching bits within the block is greater or equal to some pre-defined threshold zₜₕᵣₑₛₕ, then the number of matching blocks is incremented. A typical value for zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the data base from scans of different objects of similar materials, e.g. a number of scans of paper documents etc. For the case of q=4, k=4 and z_{threshold}=13, we typical value of s is 0.1. If the qk bits were entirely independent, then probability theory would give s=0.01 for z_{threshold}=13. The fact that a higher value is found empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

Thus there have now been described a number of examples arrangements for scanning an article to obtain a signature based upon intrinsic properties of that article. There have also been described examples of how that signature can be generated from the data collected during the scan, and how the signature can be compared to a later scan from the same or a different article to provide a measure of how likely it is that the same article has been scanned in the later scan.

Such a system has many applications, amongst which are security and confidence screening of items for fraud prevention and item traceability.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a non-linear article transport system is used, such as within a machine where an article is moved along an article transfer path, or where a human directly provides a transport motion for the article.

As described above, where a scanner is based upon a scan head which moves within the scanner unit relative to an article held stationary against or in the scanner, then linearisation guidance can be provided by the optional distance marks 28 to address any non-linearities in the motion of the scan head. Where the article is moved by in a non-linear transport system, these non-linearities can be greatly exaggerated. Also, where such linearisation marks are not available, even an article transport system which appears to be highly linear on a macroscopic scale may be significantly non-linear on the scale of the surface texture of an article to be scanned.

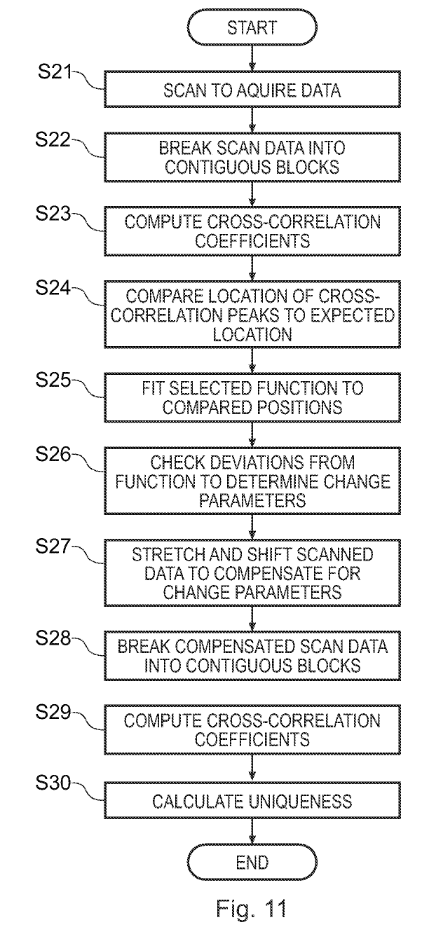

To address recognition problems which could be caused by these non-linear effects, it is possible to adjust the analysis phase of a scan of an article. Thus a modified validation procedure will now be described with reference to FIG. 11. The process implemented in this example uses a block-wise analysis of the data to address the non-linearities.

The process carried out in accordance with FIG. 11, can include some or all of the steps of smoothing and differentiating the data, computing and subtracting the mean, and digitisation for obtaining the signature and thumbnail described with reference to FIG. 9, but are not shown in FIG. 11 so as not to obscure the content of that figure.

As shown in FIG. 11, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan length of 64 mm is divided into eight equal length blocks. Each block therefore represents a subsection of scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case were a perfectly linear relationship to exist between the original and later scans of the article.

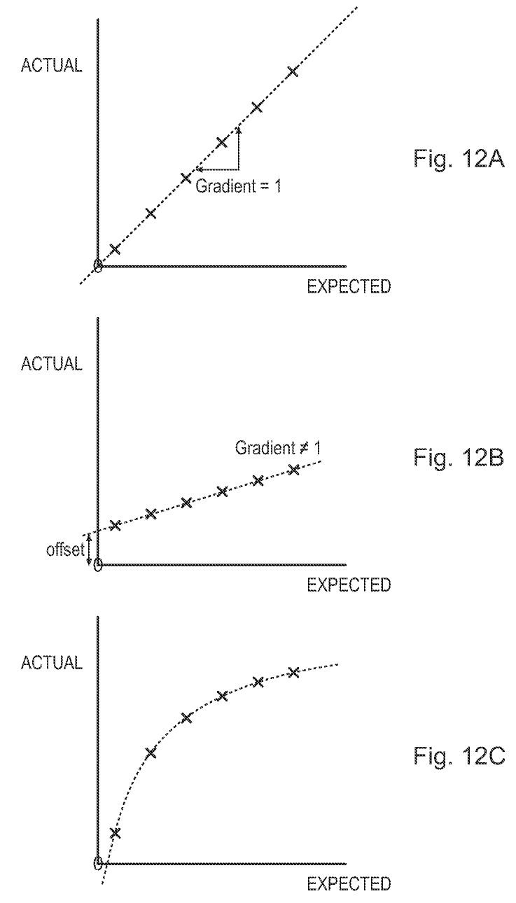

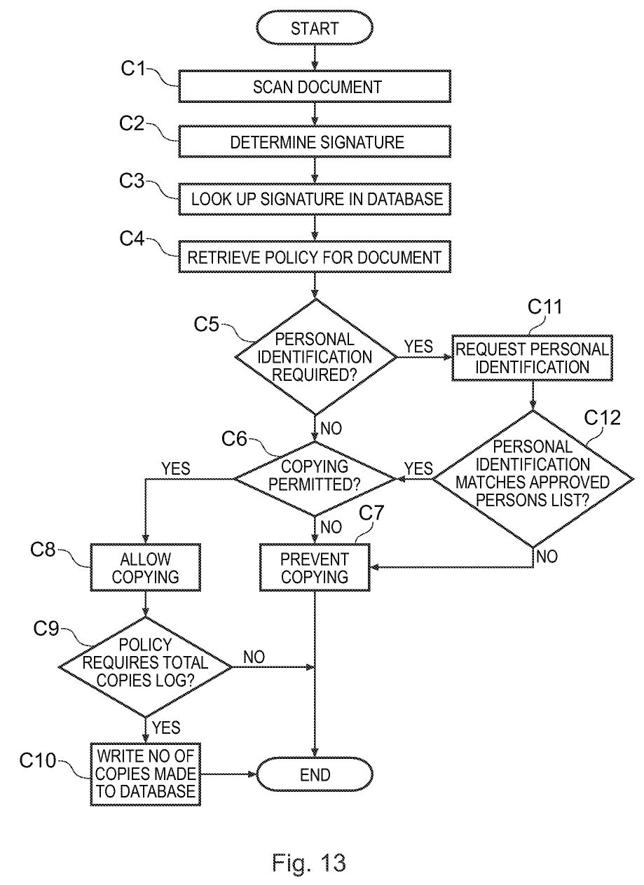

This relationship can be represented graphically as shown in FIGS. 12A, 12B and 12C. In the example of FIG. 12A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 12B, the cross-correlation peaks are closer together than expected, such that the gradient of a line of best fit is less than one. Thus the article has shrunk relative to its physical characteristics upon initial scanning. Also, the best fit line does not pass through the origin of the plot. Thus the article is shifted relative to the scan head compared to its position upon initial scanning.

In the example of FIG. 12C, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position upon initial scanning.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x² functions and x³ functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving licence or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof. Damage or alteration in other regions may be ignored, thereby allowing the document to be recognised as authentic.

In some scanner apparatuses, it is also possible that it may be difficult to determine where a scanned region starts and finishes. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

Thus there has now been described an number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

Referring again to FIGS. 4 and 5, and with reference to the processing techniques and approaches described with reference to FIGS. 6 to 12, it is apparent that a document to be copied using a copier machine (such as a photocopier, facsimile machine or scanner/printer pair) can be identified using a scan head using one or more of the techniques described above. Likewise a document copy output from such a machine can also be scanned using a scan head using one or more of the techniques outlined above.

Thus there has now been described an example of a scanning and signature generation apparatus suitable for use in a mechanism for traceable and secure copying of documents. Such a system can be deployed to allow a document to be scanned as part of a copying or electronic transmission process (such a transmission process can be considered to be a copying process where the copy is produced at a location remote the document being copied). Thereby, a document to be copied can be scanned by a scan head and a signature derived therefrom can be checked against a database of signatures to determine whether the document has been recorded in the database. If the document is not recorded in the database, then copying can be either prevented (in an example where only documents recorded in the database can be copied) or allowed freely (in an example where copying of documents not recorded in the database is freely allowed). If the document is recorded in the database, then a checking process can be followed to determine whether copying of the document is permitted using the copying device (photocopier, fax machine etc) at which the document has been scanned. Possible outcomes of the checking process can include: copying permitted (possibly subject to a maximum number of copies); and copying not permitted. Depending upon the outcome of the checking procedure copies of the document may be produced using the copying apparatus.

In order to limit further copying of the document, the copies made by the copying apparatus can be scanned during the copy creation process. As illustrated with reference to FIGS. 4 and 5 above, an output tray of a copying apparatus can be equipped with a scan head for taking a signature from the newly created copy. As will be appreciated, this scan head can be placed anywhere within the paper path of the copying machine. In some examples, the scan head is placed in a part of the paper path which ensures that the newly created copy is scanned before a user can access the copy to remove it from the copying machine. The signature of the each new copy can then be added to the database so as to provide for copy limitations on the new copy. In some examples, it may be desirable that the new copy cannot be used for further copies or may have a copying policy different to that of the “parent” document. In such an example, the signature for the copy may have a database record distinct from the record for the original document, such that the new record can be marked to never permit copying. In other examples, the new copy may have the same copying restrictions as the “parent” document, and thus the signature of the copy may be added to the record for the parent document as another signature which can be used to authorise copying.

In some examples, further security and traceability of documents and copies thereof can be applied using a security mechanism to control access to a copy apparatus. For example, a user of the copy apparatus can be required to provide some form of identification before being allowed to operate the copy machine. This could be performed by requiring a security pass, token, key or keycode to be presented for access to the copy machine or before performing a copy function using the copy machine. Thus a copy restriction for a given document can be made specific to a given individual. Thereby, the results from a checking procedure to determine whether a document can be copied can be tailored to a specific user.

An example of a checking process which could be carried out to determine whether to allow a document to be copied is shown in FIG. 13.

The process starts at step C1 where the document is scanned at a copy machine document input. The scan results can then be used to generate a signature for the document at step C2. Steps C1 and C2 can basically follow the processes described above with reference to FIGS. 9 and 11, using any or all of the optional steps that may be desired.

Next, at step C3, the determined signature can be compared to a database of signatures, for which the steps outlined with reference to FIG. 10 above may be used. Once a database match is found, a copying policy for the document can be retrieved, at step C4, from the database records associated with the matched signature. The retrieved policy can then be checked at step C5 to determine whether a personal identification is required to copy the document, such that only a predefined list of persons have permission to copy the document, or if it is desired to trace the originating person for all copies made of a document.

If no personal identification is required, then at step C6 the policy can be checked to determine whether copying of the document is permitted. This check may include checking whether a copy limit has already been reached, as well as whether the document is allowed to be copied.

If copying is not to be permitted, then at step C7 copying of the document is prevented, which may result in the document being returned to the user, or the document may be retained by the machine for later retrieval by an authorised administrator. Following this, the process ends.

On the other hand, if it is determined at step C6 that copying is to be permitted, then at step C8 the copy making is allowed. This copy making may be limited to a maximum number of copies. Once the copies have been made, a check is performed at step C9 to determine whether the policy for the document requires a log to be kept of the number of copies made. If not, the process ends. If so, then at step C10 a record of the number of copies made is written to the database, following which the process ends.

If it is determined at step C5 that personal identification is required, then at step C11 a request for personal identification is made to the operator of the machine. This request can be indicated through a visual signal, or by an audible signal, or both. The personal identification can be by way of identification code, or by means of an identification article such as a key or a token, such as a magnetic swipe card, a smartcard or a radio frequency identification (RFID) tag. In some examples, the identification article may be scanned by a scan head operable to determine a signature for the article in much the same way as described above with reference to FIGS. 1 to 3 and 6 to 12. In some examples, the identification provided can be checked against a database of identification details to allow the validity of the identification to be checked.

The provided personal identification is then checked at step C12 against a list of authorised operators held in the document policy. In another example, a list of documents or document categories which the operator is authorised to copy can be associated with the personal identification, either in an identification article or in a database of identification details in a record related to the identification article or code. If it is determined that the operator is not authorised to make a copy of the document, then processing continues at step C7 where copying is prevented. If, on the other hand, it is determined that the operator is authorised to copy the document, processing continues at step C6 where the “copying permitted?” is performed. This check is performed additionally to the identification check in the present example a the check at step C6 can include a check against a maximum number of copies threshold which may apply independently of the individual authorisation. Also, a particular document may have an overriding “do not copy” instruction which overrides an individual's authorisation to make copies.

In some examples, multiple scan heads may be provided in the copy machine to allow for misalignments of documents and copies as they pass through the machine. Thereby, erroneous rejection of documents for copying can be reduced by maximising the likelihood that the scan of the document matches a stored signature therefor. Likewise, by making multiple scans of the copy, a number of signatures for that copy can be stored, increasing the likelihood that the document will not be erroneously rejected during later verification scanning. Due to the extremely high confidence a positive match of such a signature creates, allowing multiple slightly different scans of the article to create a valid signature has a negligible effect on the confidence in a positive match.

Thus there has now been described various methods and apparatus for controlling the copying of documents. The controls can be applied per document, per document type (e.g. classification rating, commercial sensitivity etc), per user, per copy type (e.g. unitary photocopier, facsimile transmission etc) or for any combination of the above.

In some examples, such a system can be implemented to provide for authorised copying of sensitive or classified documents. Such documents could include commercial information or identification documents such as passports, driving licences and other identity cards or tokens. Thus a copy of such a document can be “certified” by the machine used to copy the document. This certification can take the form of the biometric signature of the copy being recorded in a database storing details of such certified copies. Thus, for example, a certified copy of an identification document could be provided to a financial services company for identifying an applicant for a product such as a loan. Thereby the financial services company can be certain of the authenticity of the copy and the owner of the passport need not surrender the passport to the company while the company performs checks based on the passport.

Also, the individuals authorised to make such copies can themselves be restricted and limited by use of an ID based copying authority. Thus commercially sensitive documents can be distributed to a number of persons, only a limited number of whom have the authority to make further copies, or to transmit those documents via facsimile. Such a system could be used to prevent commercially sensitive or classified documents from being transmitted outside of an office or facility in which their presence were authorised. In one example, such a system could be utilised to restrict the ability for classified or secret documents to be circulated outside a predefined set of authorised persons. In another example, such a system could be used for policing of confidentiality agreements and/or joint venture agreements. According to such an example, all documents covered by the agreement could be tracked and/or controlled and possibly a requirement for destruction at the end of the agreement could be implemented.

In some examples, further copying can be restricted. For example, a document such as a passport is typically not limited to be present in certain restricted areas only. Thus a copy of that passport may be made on any copy apparatus without restriction, and copies of copies (i.e. second and subsequent generation copies) may be made. However, where a certified copy of the passport is required, a copy apparatus incorporating biometric scanners (such as the scan head 10) can check an existing copy of the passport to determine whether that existing copy is certified. If it is determined to be certified, then further certified copies may be made from that first certified copy. If the first copy is not certified, then either un-certified copies can be produced, or copying may be prevented. Thus secure certification of documents without needing access to the original can be performed. Such a process could be used for any document of which a certified copy is desired, in addition to passports, other identification or entitlement documents or tokens such as driving licences or identification cards could be used. Also, official documents such as certificates of incorporation of businesses, or invoices could be copied in this way.

In some examples, the use of an identification system to ensure that only authorised users can copy a document can be used to trace documents. If, at the time of copying, the individual identified as being the operator authorising a copy to be made is recorded in a database storing details of copies made, then each copy can later be scanned to create a signature, which signature can be compared to the database to determine who made the copy. Thus, for example, leaked commercial or government documents could be traced to the person who made the copy. Thereby the tracing of any leaks of information could be simplified.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

1. A system for controlling reproduction of a document, the system comprising:
a signature determination unit operable to determine a signature from a document based upon an intrinsic characteristic of the document;
a comparison unit operable to compare the determined signature to a stored signature; and
a reproduction apparatus operable to create a reproduction of the document in dependence upon a comparison result from the comparison unit.

2. The system of claim 1, wherein the signature determination unit comprises:
a reading volume for receiving the document;
a source for generating a coherent beam;
a detector arrangement for collecting a set comprising groups of data points from signals obtained when the coherent beam scatters from different parts of an article in the reading volume, wherein different ones of the groups of data points relate to scatter from respective different parts of the article; and
a data acquisition and processing unit for determining a signature of the article from the set of groups of data points.

3. The system of claim 1 wherein the comparison unit is further operable to retrieve a stored reproduction policy for the document.

4. The system of claim 3, wherein the reproduction apparatus is operable to create a reproduction of the document in dependence upon the retrieved reproduction policy.

5. The system of claim 1, further comprising an identification verification unit operable to determine whether a provided identification input matches to a user authorised to create reproductions of the document.

6. The system of claim 1, wherein the reproduction unit is operable to create a reproduction of a document in dependence upon one or more or a document identity, a document type, a user identity, and a reproduction type.

7. The system of claim 1, wherein the reproduction unit comprises one or more of a photocopier, a facsimile machine, a scanner and a printer.

8. The system of claim 1, wherein the document is one or more of an identification document, a classified document, and a commercially sensitive document.

9. The system of claim 1, further comprising a signature determination unit operable to determine a signature from a reproduction of a document based upon an intrinsic characteristic of the reproduction, and a storage unit operable to store the determined signature in a database of reproduction signatures.

10. The system of claim 9, wherein the stored signature has associated therewith a reproduction policy.

11. A method of controlling copying of a document, the method comprising:
determining a signature for a document based upon an intrinsic characteristic of the document;
comparing the determined signature to a stored signature; and
creating a copy of the document in dependence upon a comparison result.
